(19) United States
(12) Patent Application Publication
(10) Pub. No.: US 2009/0038766 A1
(43) Pub. Date: Feb. 12, 2009

(54) "Car Hat", a portable sunshade canopy for automobiles

(76) Inventor: William Louis Smith, JR., Ashland City, TN (US)

Correspondence Address: William L. Smith Jr., 1100 Pondcreek Rd., ASHLAND CITY, TN, 37015, US

(21) Appl. No.: 11/890,236

(22) Filed: Aug. 6, 2007

(51) Int. Cl. B60J 11/04

(52) U.S. Cl. 160/370.21; 296/1.07

(57) ABSTRACT

This portable automobile canopy of lightweight materials and textile cloth utilizes post and sleeve mechanisms, sliding base trucks at member attachment points, a new approach of limiting coverage and a unique vehicle attachment system of hi-load lever action mechanical suction cups offering ease of deployment and car-trunk storage. Lateral boom sliding bases contribute to provide adjusting lengths and spring rollers the width of the vehicle at their ends house canopy cloth and bridge the left and right sides of the vehicle. The middle rail bridges the roof and adjust in height with the post and sleeve function. Other interconnected configurations utilizing combinations of lever action suction cups that attach to the same as described or other vehicle glass for various lightweight structural shading and other applications with this attachment method are introduced now and considered exclusive new art.

### CROSS-REFERENCE TO RELATED APPLICATIONS

Not Applicable

### FEDERALLY SPONSORED RESEARCH OR DEVELOPMENT

Not Applicable

### COMPACT DISK APPENDIX

Not Applicable

### BACKGROUND OF THE INVENTION

This application is in the category or class providing shade specifically for a stationary automobile or other vehicle while structurally supported by the vehicle. The following prior art patent applications relate by varying degrees to this classification:

U.S. Pat Nos. 706,605, 2,480,509, 2,508,757, 2,571,362, 2,598,940, 2,608,942, 2,646,047, 2,736,375, 2,798,501, 2,849,012, 2,858,837, 2,874,709, 2,989,967, 3,044,477, 3,055,381, 3,143,123, 3,349,784, 3,785,697, 3,952,758, 3,957,301, 3,992,053, 4,164,233, 4,184,501, 4,402,544, 4,432,581, 4,519,409, 4,519,644, 4,605,030, 4,683,900, 4,683,902, 4,684,165, 4,711,260, 4,718,711, 4,720,135, 4,727,898, 4,805,654, 4,825,889, 4,828,985, 4,834,128, 4,834,158, 4,856,842, 4,858,985, 4,886,083, 4,889,171, 4,925,234, 4,994,321, 5,013,079, 5,040,557, 5,094,157, 5,116,258, 5,240,305, 5,241,997, 5,287,871, 5,350,000, 5,522,409, 5,579,796, 5,850,843, 5,921,259, 6,257,259, 6,260,566, 6,607,002, 6,705,664

Many vehicle attached canopy applications listed only provide shade to exterior side areas of vehicles. Many applications designed to shade vehicles are statically tethered to satellite structures or require vehicle wheels rolled up on anchoring components, preventing the vehicle from minor movement. Many designs prohibit access to the vehicle's interior. Many automobiles covers do not provide for the movement of air, essential for mitigating heat, but are complete car covers which trap heat and or apply friction to the vehicle's finish. Many devices are bulky and cumbersome, requiring unusual strength or assistance for deployment, and are too large for storage into a vehicle's trunk.

### BRIEF SUMMARY OF THE INVENTION

This application is in the category or class providing portable shade specifically for a stationary vehicle and its occupants while structurally supported entirely by the vehicle. It is unique an improvement from the prior examples listed in the following manners:

A portable sunshade canopy device for automobiles is disclosed, of lightweight structural materials, textile cloth and articulating components providing for ease of deployment, functionality and fold-up car-trunk storage.

This invention allows the owner to park an automobile in the sun, retrieve from the trunk and quickly deploy a lightweight canopy structure over the cab of the vehicle. This item drastically reduces the sun's rays from hitting the roof of the car, consequently lowering the interior temperatures of the vehicle's cab space. When returning to the automobile after shopping or a morning at work, storage is quick and the owner will find the automobile's interior significantly cooler. This device will also increase the comfort of the owner who spends time with stationary vehicle, such as in the driveway while cleaning or repairing the vehicle, or at beachside seeking shelter from the sun.

This invention is designed allowing access to the interior of the vehicle while the apparatus is deployed. Design improvements allowing rear passenger door entry with 4-door vehicles are obvious developments toward the preferred embodiment of the apparatus.

An automobile's finish is easily marred by many designs with components that rest on the vehicle. Even a protective rubber pad can scratch off paint if any dirt or sand is on the vehicle. This portable automobile canopy's design avoids contact with the finish by connecting primary structural components to the exterior of the vehicle's windows via high capacity mechanical “lever-action” suctions cups. Since the canopy structure is light weight and designed for limited translation of forces to the window relative to the window's strength, this application does not compromise the vehicle's glass components. The application of these type suction cups for the support of articulating and connected shade canopy structures has not been utilized in prior art and this invention is the first to utilize this combination of components for this purpose.

This invention utilizes the prior art of the post and sleeve reverse fold-up and adjusting length motion of a typical compact circular umbrella with a double sided and larger interconnected rectangular canopy variation, introduced now as new art because only with this invention this function is successfully utilized with an automobile canopy.

Just as with traditional canopy structures, the primary mechanism for the cooling effect of this invention when utilized with an automobile is the open and shaded air gap between the surface of the object to be kept cool and the surface receiving the sun's radiation. This invention is the first to utilize this traditional concept in a portable canopy made portable primarily by its limited coverage, that is, concentrating shading over the cab roof and not the hood or trunk. By only shading the area occupied by passengers combined with the other contributions of this disclosure, this invention is the first to offer this level of portability and ergonomic sophistication to a portable automobile sunshade canopy device. This approach of limited size is advanced once again by introducing the factory/after-market rigid installation of the pop-up roof providing a new and unique manner to apply these concepts to a more permanent apparatus. The mechanism would require a vehicle to be stationary.

By the manner of these listed solutions to previous design flaws, this apparatus is a better product than and unique from previous inventions presently holding patents for the type of invention of the portable automobile shade canopy classification.

### BRIEF DESCRIPTION OF THE SEVERAL VIEWS OF THE DRAWING

### Listing of Figures

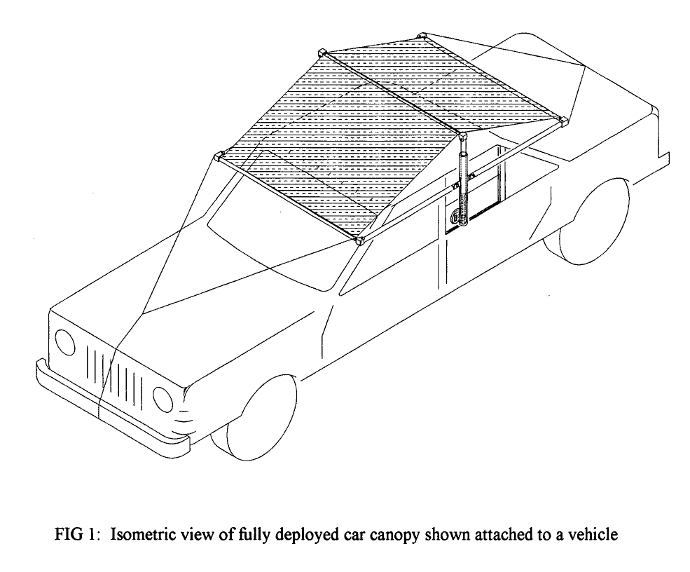

FIG. 1. Isometric view of the application of a portable sunshade canopy deployed on automobile. Please note that the application is for a stationary vehicle. The drawing depicts an item made of light weight materials designed for quick installation and removal, attached to a vehicle by suction cups to the vehicle glass as shown. The item spans the vehicle from side to side with a rectangular shaped canopy. The canopy fabric can be slatted allowing for limited wind conditions. Included are anchoring guy lines for attachment to bumpers which would include a felt strip for protecting the finish at those minor contact points.

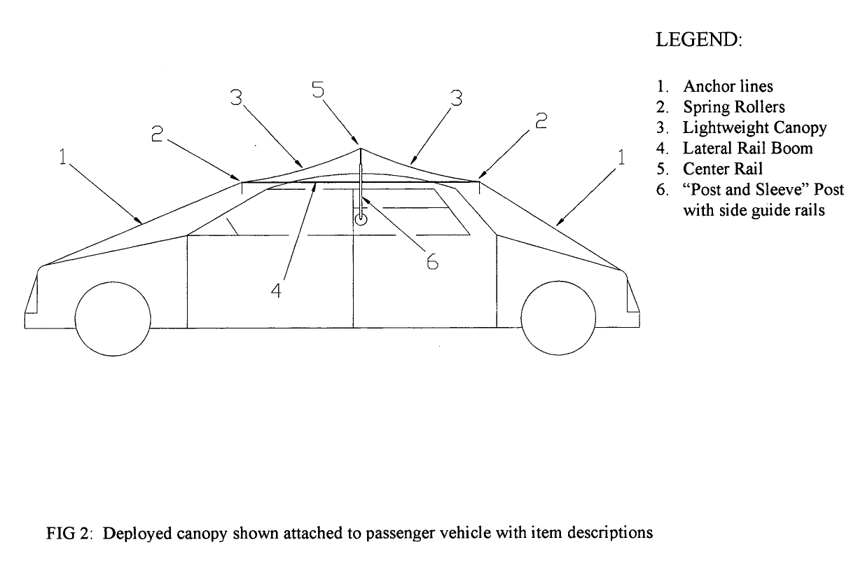

FIG. 2. Profile view of a portable sunshade canopy in profile with item descriptors. The folding mechanism includes a spring loaded sleeved post with tracks at the sides controlling the pivoting ends of the horizontal rail booms, these with rotating bases on lever action suction cup armatures. Unique features of the post and sleeve are the tracking pivot components and the spring extension of the post, matching lateral rail lengths. Lateral rails are composed of the center rail and the end rollers, which take up the fabric when the canopy is collected for storage and deliver it during deployment.

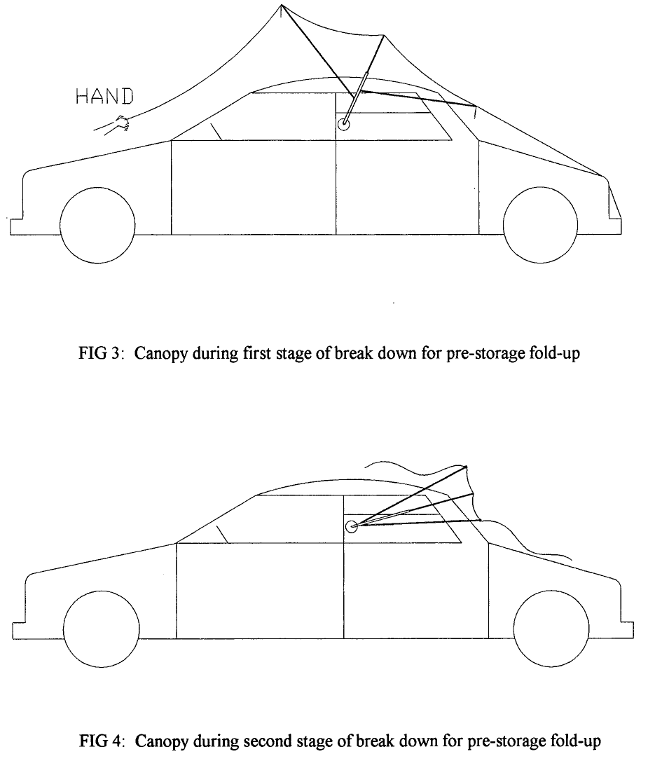

FIG. 3. Profile view of the portable sunshade canopy showing the first stage of breakdown for pre-storage fold-up. Notice as the anchor line from the front of car is released, the apparatus immediately begin folding itself up, due to various springs style resistances that have been under tension and compression.

FIG. 4. Profile view of the portable sunshade canopy showing the second stage of breakdown for pre-storage fold-up. Notice that at this stage, all the articulating members are matching up in lengths, allowing the low profile characteristic of this A-frame shape to conform with the canopy's deployment required geometry.

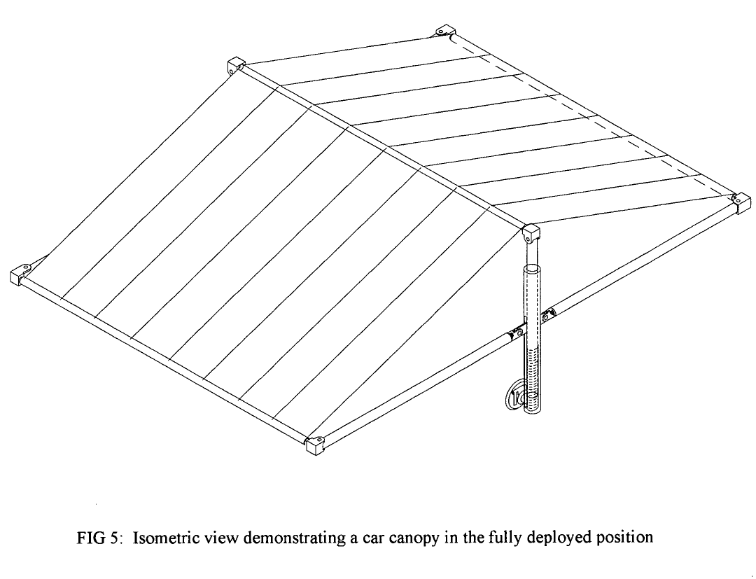

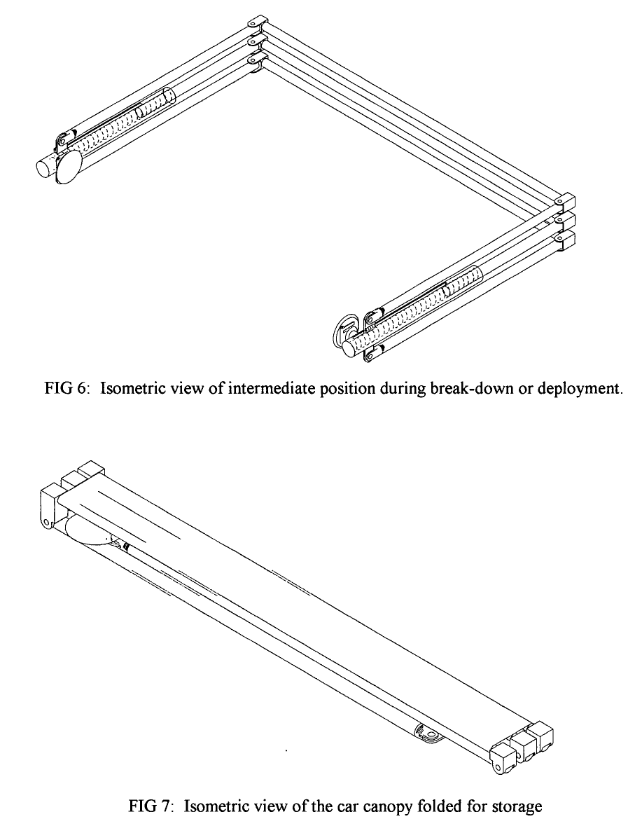

FIG. 5. Isometric view demonstrating a car canopy in the fully deployed position. Notice the length and position of the various components as they vary from FIG. 6. The components line up as shown previously in FIG. 1.

FIG. 6. Isometric view demonstrating a car canopy in the intermediate stage of deployment. The apparatus at this stage of deployment would have been resting at the front of the trunk lid near the rear window while the two “arms” were folded out and rolled forward. At this position the mechanical “lever-action” suction cups are lined up and attached to the passenger windows. Note the new position of the roller rails and boom bases at the posts, the collecting of canopy fabric and the matching lengths of the center posts and rails.

FIG. 7. Isometric view demonstrating the car canopy in the fully folded position ready for storage or just retrieved from the trunk. Notice the convenient shape of the apparatus. Total length is designed for car trunk storage, larger vehicle owners will opt for larger car canopies.

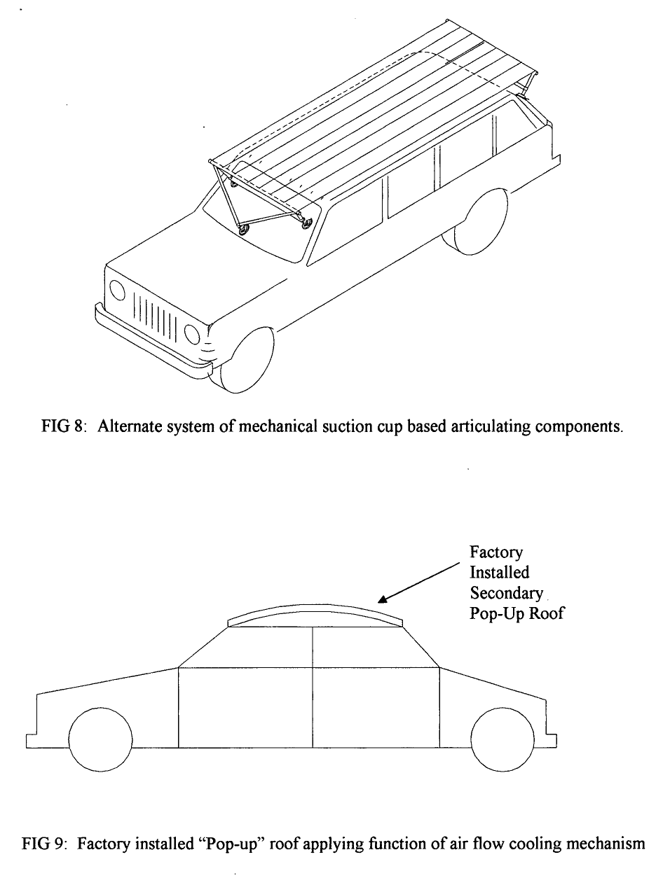

FIG. 8. Depicts an alternate configuration utilizing high-capacity mechanical suction cups connected to the vehicle glass exterior interacting in combination with articulating rigid members and textile cloth proving an easily deployable and storable canopy for automobiles. Obvious improvements and variations combining side windows with windshield or rear window attachments are claimed now as new art. This claim includes alternate suction cup combination configurations to exterior of window structures providing platforms for prior art not restricted to automobile shading.

FIG. 9. Depicts the application of a secondary roof in a factory or after market “pop-up” installation. This variation reinforces new art claim of near shade of limited coverage utilizing horizontal air flow mitigating heat by allowing moving air to remove it. This feature's engagement would be restricted to stationary vehicles, with the preferred embodiment applying control features active while the owner is away.

### DETAILED DESCRIPTION OF THE INVENTION

This invention is of conceptually simple form and function, requiring a moderately limited number of moving parts, and comprised in the preferred embodiment of lightweight components, such that deployment with no assistance is possible by the least hardy individual.

This apparatus is designed for complete car trunk storage, unlike devices requiring permanent affixtures to the automobiles exterior, bumper or chassis, or storage at home. The deployment of this device requires no attachment to satellite structures or buildings, allowing for unlimited choices of location. This device requires no tire-wheel “hold-down” stanchion anchor mechanism. This application does not mechanically attach by bolting or cinching to the vehicle's bumpers, side panels, hood, trunk or roof, or, utilize suction cup mechanisms to the vehicles roof or other finished panels.

These features allow minor movement of the automobile while the device is deployed, an advantage in busy home driveways, beachside parking or tailgating environments where minor vehicle movement is expected.

This invention is designed allowing access to the interior of the vehicle during deployment. Many previous canopy designs do not allow vehicle interior access while in use. This design presently restricts rear door access with 4-door vehicles. This limitation will be mitigated with obvious design improvements allowing vertical column rotation that will permit rear door access with 4-door sedans.

The apparatus described will be constructed with regard to manufacturing efficiencies, weight, strength characteristics and environmental stewardship. A prototype requiring the application of metallic pipes and railings was developed and successfully deployed with the geometries providing a stable structure. Material improvements toward composite and plastic materials considered are to further improve weight, rigidity, ease of deployment, storage and to mitigate possible marring of automobile finishes.

Major components of the preferred embodiment of the device comprise of two a-frame forms, each at the left and right sides of a typical sedan vehicle. A vertical post divides the a-frame forms into front and back sections. Between the tops of the posts runs the center lateral member, bridging the roof of the car and connecting the left and right side a-frame forms. Each a-frame also consist of rearward and forward horizontal booms attached midway to front and back sides of the posts. At the far ends of the horizontal booms are attached spring rollers, the length of which generally matching the width of the vehicle, also bridging the car and connecting left and right sides. These house the canopy cloth, spanning across the vehicle and rolling out forward and over to cover the vehicle cab and unifying the left and right side a-frame forms into a rectangular canopy shape. At the bottom ends of each posts are connected high capacity mechanical suction cups. The suction cup's housing and post connection provide a pivot function and are attached to the exterior of the vehicle window glass. Deployment consist of laying the apparatus upon a closed trunk and folding out the members with the suction cups to where they are aligned outside the left and right passenger windows. Following attaching the suction cups to the windows and locking in the cups' lever engagements, the rear guy line from the back roller is attached to the rear bumper by simple hook, and the front guy line is grasped for canopy deployment. The front guy line controls roll out of the front roller towards the front of the vehicle. The apparatus will during this function take on the a-frame tent form over the cab of the vehicle while the center post height adjusts, lowering the peak for a flatter profile. Shade coverage matches the width of the vehicle and extends just past the rear and back ends of the cab roof. Basic design focus providing partial shade can be modified as obvious improvement for expanded coverage with canopy textile/cloth add-on features.

Included in the following claims of exclusivity are any future apparatus or complimentary improvements to prior apparatuses utilizing combinations of high capacity mechanical suction cups to exteriors of windshields, side or rear windows or for the temporary attachment of shade canopy devices or other lightweight articulating structures to stationary vehicles utilizing the now introduced art of this system of structural support. Included in the following claims of exclusivity are any future apparatus or complimentary improvements to prior apparatuses utilizing the unique fold-up of the rear and forward booms on each side of the vertical post, the vertical sliding of the inner boom connections along these posts, the adjusting height characteristic of the post and sleeve application to provide the lower profile roof and height re-alignment for final fold-up and storage position including not yet introduced combinations of springs, air pistons or any other movement resistance or assistance or lock-in-place devices to facilitate the deployment of this invention as these are considered obvious improvements toward the preferred embodiment of this invention. This application utilizes the prior art of spring loaded canopy rollers or other styles of shading mechanisms with a unique combination of these with high capacity mechanical suction cups in an unlimited variation of combinations as described by the examples of FIGS. 1 and 8. The usage of spring loaded canopy rollers or other styles of shading mechanisms is not unique for automobile shades but will receive obvious improvement considerations toward the development of this unique application.

1. Utilizing the exterior of the vehicle's glass for attachment of interconnected combinations of structural members to the vehicle using high capacity lever action mechanical suction cups in multiple variations provides with this invention a unique and adequate structural connection mechanism for limited and lightweight applications including portable vehicle shading devices not available in prior art.

2. The reverse slide mechanisms of the post attaching to the mechanical lever action suction cups of claim 1 and sliding boom components allowing vertical fold-up and canopy roll-up while adjustment of component lengths align the geometries of members required for final fold-up and compact storage of a rectangular shade canopy of limited coverage are inventions not available in prior art.

3. Limiting shade coverage to focus on cooling passenger spaces while discarding typical concerns of protecting the vehicle's finish from the sun's radiation which would include coverage of hoods or trunks that other products offer is how this item instead emphasizes the need for cooling and portability made possible by articles disclosed in claims 1 and 2 and this invention advances further this field of endeavor with introducing a factory or after market rigid permanent installation with automated or manual pop-up functions providing adequate shade over the cab roof of a parked vehicle as a unique invention not available in prior art.

4. The combination of the lever action suction cups of claim 1 with the sliding and adjusting length mechanisms of claim 2 and the concept of limiting shade coverage to passenger spaces introduced with claim 3 join with the prior art of the rolled canopy to introduce this concept of design of a rectangular shaped canopy with shade just past the front and back of the vehicle cab or other style of shading mechanism utilizing the introductions of this disclosure making it possible for the first time that a single least hardy individual can deploy a portable canopy shading device for a parked vehicle with efficient effort and time.
